(19) United States
(12) Patent Application Publication
(10) Pub. No.: US 2020/0156394 A1
(43) Pub. Date: May 21, 2020

(54) Stand for Deposition on Organic Material

(71) Applicant: Rene Rodriguez, Layton, UT (US)

(72) Inventor: Rene Rodriguez, Layton, UT (US)

(21) Appl. No.: 16/197,155

(22) Filed: Nov. 20, 2018

(51) Int. Cl. B41M 1/30; A23N 15/06; A23P 20/25; B41F 15/08

(52) U.S. Cl. CPC B41M 1/30; A23N 15/06; A01G 5/00; B41F 15/0881; A23P 20/25

(57) ABSTRACT

A system and method of inkjet printing on organic material such as a rose petal is disclosed. The stand has an anchor member which secures the rose stem, a support beam which can be repositioned to adjust the force exerted by the beam on the rose stem, and a printing window to align the rose petals for inkjet printing.

### BACKGROUND

Inkjet printing is the process of depositing a medium, often ink, on a substrate such as paper. Ink jet printing on paper provides a controlled environment where the paper is flat and stationary, the distance between the inject printing nozzle and the substrate is controlled, thus making the resulting printing predictable.

Inkjet deposition technology has applications far beyond merely printing ink on paper. One such application is inkjet printing on organic material such as that disclosed in U.S. Pat. No. 7,089,860. However, when the substrate is no longer a uniform, smooth, flat sheet of paper the deposition results are less predictable. Thus a need exists for a system and method for positioning non-uniform substrate for deposition printing.

### SUMMARY

A stand for positioning organic material for deposition, such as ink jet printing, is disclosed. Generally there is a stand comprising an anchor member, a support beam and a printing window. The stand comprises a system wherein the organic material, such as a rose, is cantilevered, with the stem base positioned by the anchor member, the stem mid-section is passed across a support beam positioned to a height such that the rose flower is gently pressed against the frame to position the flower's petals in the correct position for deposition.

### BRIEF DESCRIPTION OF THE DRAWINGS

FIG. 1 illustrates a perspective view of stands on a base.

FIG. 2 illustrates a perspective view of two stands on a base.

FIG. 3 illustrates a side view of stands on a base.

FIG. 4 illustrates a perspective view of stands on a base.

FIG. 5 illustrates an alternative side view of stands on a base.

FIG. 6 illustrates a method of using the stand.

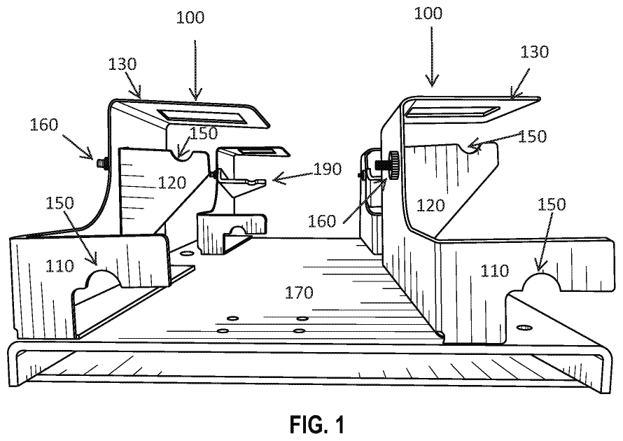

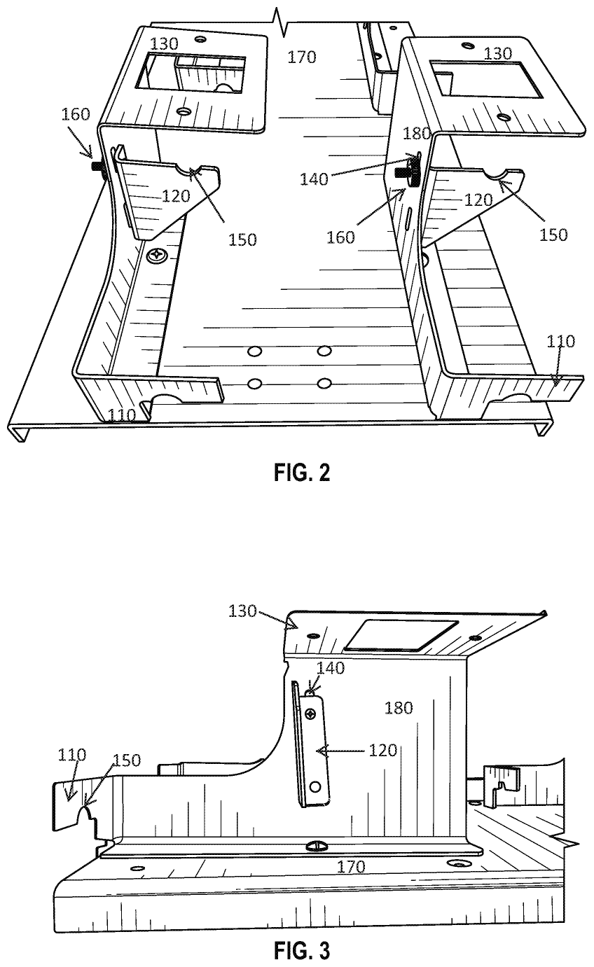

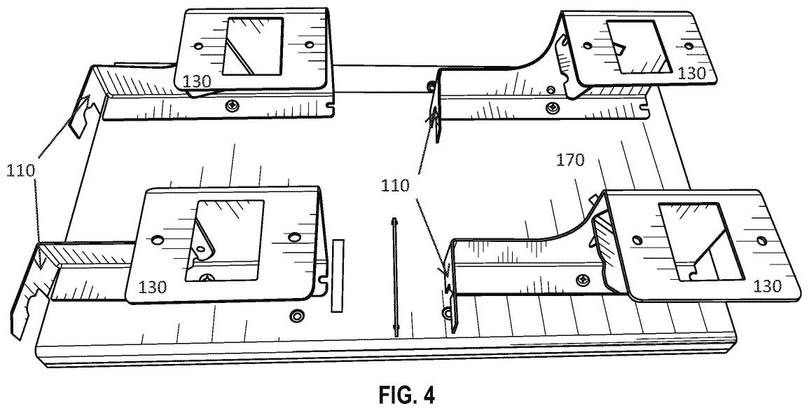

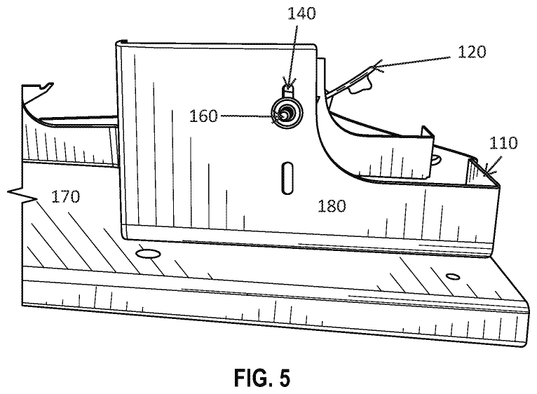

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein. Moreover, the Figures may show simplified or partial views, and the dimensions of elements in the Figures may be exaggerated or otherwise not in proportion for clarity. In addition, as the terms “on” and “attached to” are used herein, one object (e.g., a material, a layer, a substrate, etc.) can be “on” or “attached to” another object regardless of whether the one object is directly on or attached to the other object or there are one or more intervening objects between the one object and the other object. Also, directions (e.g., above, below, top, bottom, side, “x,” “y,” “z,” etc.), if provided, are relative and provided solely by way of example and for ease of illustration and discussion and not by way of limitation.

In some embodiments a stand for printing on a target, such as organic materials including a rose or other flower petal, leafs, foods such as fruits, vegetables, is provided, the stand comprising an anchor member 110, a support beam member 120 and printing window 130. In some embodiments the anchor member is positioned vertically lower and closer to the base 170 than the support beam member. In some embodiments the support beam member is vertically positioned between the anchor member and the printing window. In some embodiments the support beam member is horizontally positioned between anchor member and the printing window. In some embodiments the printing window forms a frame parallel with the base. In some embodiments an organic body, such as a rose, is placed in the stand, with the base of the rose stem secured by the anchor, the stem of the rose cantilevered over the top of the support beam member, and the petals of the rose are positioned in the window such that an inject printer can print on the petals of the rose. In some embodiments the height of the support beam member is repositioned to avoid damaging the rose stem, while simultaneously ensuring the rose petals are correctly positioned in the window. In some embodiments the position is vertical. In some embodiments the position is rotational.

A printing stand 100 for positioning organic materials for deposition is disclosed herein. In some embodiments the stand 100 comprises a rigid body and may be made from metal or plastic and can be injection molded, stamped, hydroformed or processed by hand using a break. In some embodiments the stand comprises an anchor member 110 which extends orthogonally from the body. In some embodiments the anchor member is integrated into the body and formed during processing. In some embodiments the anchor member comprises an extension of the stand and is cantilevered to the side of the body. In some embodiments the structure may be formed through stamping the body and then then forming or bending it into the desired shape. Alternatively, when the body is formed by the process of injection molding and the mold will comprise the desired shape.

In some embodiments the anchor member 110 comprises a receiving member 150 which is configured to receive the organic material, such as a rose stem, and align it with the printing window. In some embodiments the receiving member 150 comprises a lacuna such as concavity, a notch, a depression. However in some embodiments the receiving member 150 may comprise a securing mechanism, such as a latch, slot, or crease which is selectively coupled to the organic material and the used to secure the position of the organic material in relation to the anchor member specifically and the stand generally.

In some embodiments the anchor member 110 may comprise a structure separate from the body, but which may be positioned next to the body and may be useful when the stand is implemented into a process such as an assembly line. In such embodiments a process may comprise a first assembly station comprising securing a stem in an anchor and a second assembly station comprising aligning the rose flower with the printing window 130. In embodiments where the anchor 110 is separate from the body 180, alignment indicators, such as a mark, or a physical alignment mechanism, such as a depression or spacer is provided to guide the alignment of the anchor member 110 with the body 180.

In some embodiments the anchor member 110 may comprise a structure extending from the body 180. In some embodiments in which the anchor member 110 is separate from the body 180, the anchor member 110 may comprise a base with a receiving member 150 in which the organic material may rest for anchoring.

In some embodiments the stand 100 comprises a support beam member 120. In some embodiments the support beam member 120 is selectively coupled to the body 180. In some embodiments the support beam member 120 is structurally coupled to the anchor member 110 and independent of the body 180. In some embodiments the support beam member 120 is structurally independent from the body 180 and the anchor member 110.

In some embodiments the support beam member 120 is selectively repositionable to an open position 190 such that placement of the organic material in the stand can be done with minimal or no contact between the support beam member 120 and the organic material. Once the organic material is generally aligned in the stand 100 with the stem in the anchor member 110 receiving member 150 and the printing window 130, the support beam member 120 can then be repositioned to a closed position 120. The height or distance of the support beam member 120 from the base is set by positioning the support beam member along the track 140 and the loosening of the nut 160 which is used to selectively position the height and orientation of the support beam member 120. In some embodiments the organic material is aligned with the stand 100 with the support beam member 120 in the open position 190. In some embodiments once the organic material is aligned the support beam member 120 is rotated into the closed position, generally orthogonal the printing window 130, and the height of the support beam member 120 is adjusted to create a small upward force or bias on the organic material which gently presses the organic material deposition surface, such as a rose petal, against the printing window 130. In some embodiments this alignment places the organic material, such as a rose petal flush against the underside of the printing window and places the organic material in a position so that deposition printing can occur with predictable results and without damaging the organic material. In some embodiments the alignment of the organic material occurs by hand to ensure the proper amount of force is used. In some embodiments the alignment of the organic material is automated.

In some embodiments a pivoting mechanism 160 comprises a nut, hook and loop, notch and bar or magnet which is configured to allow the support beam member to be selectively pivoted and adjusted as desired. In some embodiments the support beam member 120 further comprises a receiving member 150 configured to receive a portion of the organic material and further align the organic material with the printing window.

In some embodiments the base 170 may comprise multiple stands 100 on the same base.

In some embodiments the stand comprises a printing window 130 or frame. In some embodiments the window comprises a flat, solid structure framing an aperture through which a deposition can be made. In some embodiments a distal-facing window surface, which faces away from the base, sets the height at which the deposition occurs. In some embodiments the plane formed by the window aligns the height of the deposition plane, or the plane in which the deposition occurs. In some embodiments the deposition comprises an inkjet printer depositing material on the surface of an organic body, such as a rose petal. In some embodiments where the organic material is a rose and the deposition surface is a rose petal, the rose stem base is biased against the receiving member 150 of anchor member 110, the middle section of the rose stem is biased against the receiving member 150 of the support beam member 120, and the rose flower is biased against the proximal side closest the base, or underside of the window 130 such that the rose petal is presented as a flat surface upon which deposition will occur. In some embodiments the bias force placed on the petal in the window is modulated by the positioning of the support beam 120. In some embodiments when the rose petal presents in the window at an angle, the position of the support beam pivoting mechanism 160 is loosened and the support beam is repositioned to remove the angle and align the petal with the plane of the window 130. In some embodiments the amount of bias can be selectively applied so as to not damage the organic material. In some embodiments the stand comprises the anchor member 110 and the support beam member 120 cantilever off the same side of the body 180.

In some embodiments the stand comprising at least one adjustment track 140 from which the support beam member extends and which track is configured to allow the support beam member to be selectively positioned along the track. In some embodiments the support beam member is horizontally positioned between the anchor member and the printing frame. In some embodiments the support beam member is vertically positioned between the anchor member and the printing frame.

In some embodiments the anchor member 110 and support beam member 120 each further comprising a receiving member 150. In some embodiments the support beam member further comprises a pivot mechanism 160 configured to selectively secure the second member in a position between substantially parallel the printing window and substantially parallel the first securing mechanism. In some embodiments the stand further comprising a base 170 to which multiple bodies 180 can be selectively coupled.

In some embodiments the body of claim 1 further comprises a primary support member 180 which supports the printing window 130 orthogonal the primary member 180. In some embodiments the anchor member extends orthogonal the primary member. In some embodiments the stand comprises an anchor member 110, a support beam member 120, and a printing window 130 wherein the anchor member 110, support beam member 120 and printing window 130 are configured to cantilever a rose stem and rose flower so as to press a rose flower against the printing window 130. In some embodiments the anchor member comprises a receiving member 150 configured to receive a rose stem. In some embodiments the support beam member 120 further comprises a receiving member 120 configured to receive a rose stem.

In some embodiments the support beam member 120 is configured to be selectively positioned to permit the adjustment of the amount of force used to press the rose petal against the window 130. In some embodiments the support beam member is configured to be selectively positioned to permit the adjustment of the angle of the rose petal against the printing window.

In some embodiments a method for positioning a rose petal in a printing window comprises providing stand having an anchor member, a support beam member and a printing window wherein the anchor member comprises an anchor, the support beam member comprises a support; cantilevering a rose comprising a stem and a flower so as to press a flower petal against the printing window by securing the base of the stem against the anchor; and placing the middle of the stem against the support beam and placing the petal against the printing window.

In some embodiments the method further requires providing an adjustment track and selectively adjusting the position of the support beam member. In some embodiments the method further comprises placing the stem in a receiving member 150 formed on the anchor member 110 and a separate receiving member 150 formed in the support beam member 120. In some embodiments the method further comprises selectively pivoting 190 the support beam member to allow the rose stem to be placed into the stand and re-pivoting the support beam member to bias the flower petal against the printing window 130.

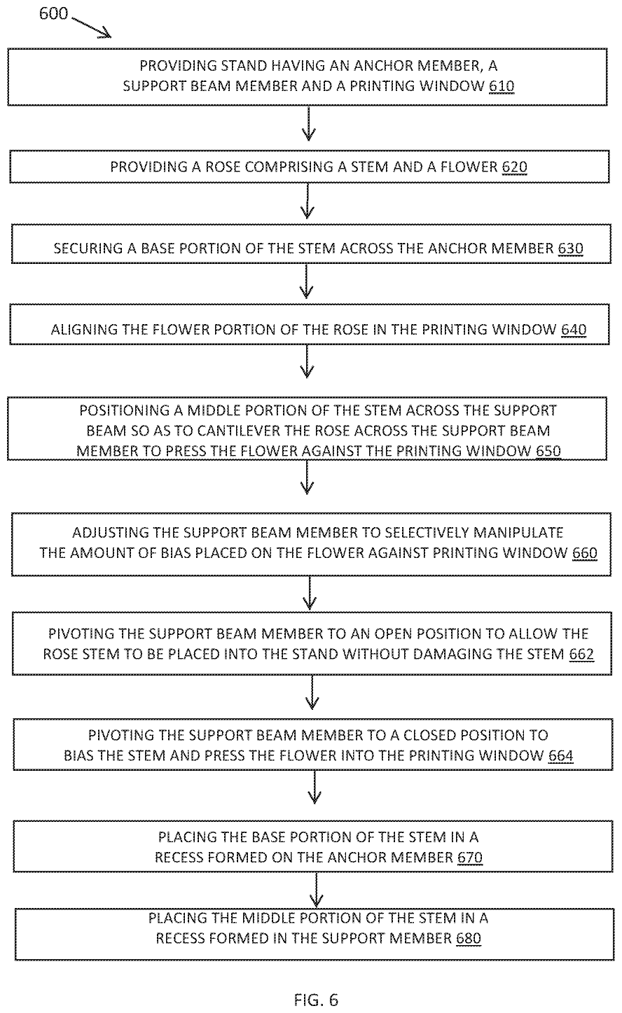

Referring now to FIG. 6, a flow diagram of an example method 600 of using a stand to print on organic material, according to some embodiments. The method may begin at block 610. In block 610, a stand comprising an anchor member, a support beam member and a printing window 610. In some embodiments, block 610 may be followed by block 620.

In some embodiments block 620 comprises placing organic material, such as a rose comprising a stem and a flower 620 into the stand. In some embodiments, block 620 may be followed by block 630.

In some embodiments block 630 securing a base portion of the stem across the anchor member 630. In some embodiments securing the rose stem in the anchor member comprises placing the stem under the member and using the rigidity inherent in the stem to bias the stem against the anchor member. In some embodiments, block 630 may be followed by block 640.

In some embodiments block 640 aligning the organic material, such as the flower portion of the rose, in the printing window 640. In some embodiments aligning the organic material comprises aligning the material along the body of the stand. In some embodiments aligning the material comprises aligning the surface of the material with the plane of the window so that deposition can occur in a predictable way. In some embodiments, block 640 may be followed by block 650.

In some embodiments block 650 positioning a middle portion of the stem across the support beam so as to cantilever the rose across the support beam member to press the flower against the printing window 650. In some embodiments, block 650 may be followed by block 660.

In some embodiments block 660 adjusting the support beam member to selectively manipulate the amount of bias placed on the flower against printing window 660. In some embodiments the bias is increased or decreased based on the position of the support beam member 120. In some embodiments, block 660 may be followed by block 665.

In some embodiments block 662 pivoting the support beam member to an open position to allow the rose stem to be placed into the stand without damaging the stem 662. In some embodiments the support beam 120 in the open position will not contact the organic material. In some embodiments, block 662 may be followed by block 664.

In some embodiments block 664 pivoting the support beam member to a closed position to bias the stem and press the flower into the printing window 664. In some embodiments the beam in the closed position will bias the organic material so as to press the flower and the material engaged with the anchor member. In some embodiments additional bias may be achieved by adjusting the position of the member in the closed position so as to reduce the distance between the support beam member 120 and the printing window 130. In some embodiments, block 664 may be followed by block 670.

In some embodiments block 670 placing the base portion of the stem in a recess formed on the anchor member 670. In some embodiments, block 670 may be followed by block 680.

In some embodiments block 680 placing the middle portion of the stem in a recess formed in the support member 680.

Although illustrated as discrete blocks, various blocks of method 600 may be divided into additional blocks, combined into fewer blocks, or eliminated, depending on the desired implementation. For example, blocks 662 or 664 may be eliminated. Furthermore, in some embodiments, the order of the blocks may be changed.

The present invention may be embodied in other specific forms without departing from its structures, methods, or other essential characteristics as broadly described herein and claimed hereinafter. The described embodiments and examples are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present inventions have been described in detail, it should be understood that the various changes, substitutions, and alterations could be made hereto without departing from the spirit and scope of the invention.

We claim:

1. A printing frame stand comprising:
an anchor member;
a support beam member; and
a printing frame wherein the anchor member, support beam member and printing frame are aligned and configured to receive and secure a target against the printing frame.

2. The stand of claim 1 wherein the anchor member and the support beam member extend off the same side of the body.

3. The stand of claim 1 further comprising at least one adjustment track from which the support beam member extends and which track is configured to allow the support beam member to be selectively positioned along the track.

4. The body of claim 1 wherein the support beam member is horizontally positioned between the anchor member and the printing frame.

5. The support beam member of claim 4 wherein the support beam member is vertically positioned between the anchor member and the printing frame.

6. The anchor member and support beam member of claim 1 each further comprising a receiving member.

7. The support beam member of claim 3 further comprising a pivot mechanism configured to selectively secure the second member in a position between substantially parallel the printing window and substantially parallel the first securing mechanism.

8. The stand of claim 1 further comprising a base supporting at least one stand.

9. The body of claim 1 further comprising a primary support member which supports the frame orthogonal the primary member.

10. The primary member of claim 9 wherein the anchor member extends orthogonal the primary member.

11. The base of claim 8 further comprising a plurality of stands.

12. A flower printing holder comprising:
an anchor member;
a support beam member; and
a printing window wherein the anchor member, support beam member and printing frame are configured to press a rose petal against the printing window.

13. The anchor member of claim 12 further comprising a receiving member configured to receive a rose stem.

14. The support beam member of claim 12 further comprising a receiving member configured to receive a rose stem.

15. The stand of claim 12 wherein the support beam member is configured to be selectively positioned to permit the adjustment of the amount of force used to press the rose petal against the printing window.

16. The stand of claim 12 wherein the support beam member is configured to be selectively positioned to permit the adjustment of the angle of the rose petal against the printing window.

17. A method for positioning a rose petal in a printing window comprising:
providing stand having an anchor member, a support beam member and a printing window wherein the anchor member comprises an anchor, the support beam member comprises a support;
cantilevering a rose comprising a stem and a flower so as to press a flower petal against the printing window by securing the base of the stem against the anchor, placing the middle of the stem against the support beam and placing the petal against the printing window.

18. The method of claim 17 further comprising:
providing an adjustment track; and
selectively adjusting the position of the support beam member.

19. The method of claim 17 further comprising placing the stem in a recess formed on the anchor member and a recess formed in the support member.

20. The method of claim 17 further comprising pivoting the support beam member to allow the rose stem to be placed into the stand; and
re-pivoting the support beam member to press the flower into the printing window.
